(19) United States
(12) Patent Application Publication
(10) Pub. No.: US 2013/0215212 A1
(43) Pub. Date: Aug. 22, 2013

(54) Mobile phone videoconferencing with incoming mobile phone calls made to different mobile phone number profiles

(71) Applicants: Chiaka Chukwuma Okoroh, Chicago, IL (US); Nathaniel A. Moore, Chicago, IL (US)

(72) Inventors: Chiaka Chukwuma Okoroh, Chicago, IL (US); Nathaniel A. Moore, Chicago, IL (US)

(21) Appl. No.: 13/385,373

(22) Filed: Feb. 16, 2012

(51) Int. Cl. H04N 7/15

(52) U.S. Cl. 348/14.02; 348/E07.083

(57) ABSTRACT

There appears to be a growing need to have a mobile phone support virtual profiles of other mobile phone lines that one user may have. The authors of this document recently proposed a solution called The Mobile Phone with Multiple Mobile Phone Number Profiles. This solution enables a mobile phone to completely assume the identity of other mobile phone numbers through virtual mobile phone number profiles. At this time, the authors of this document is proposing an enhancement to this solution. The enhancement allows a user involved in a video conference call on a mobile phone profile to accept incoming calls that are made to different mobile phone number profiles. The main catalyst for such an enhancement is ease of use.

### BACKGROUND OF THE INVENTION

There may be situations in which a person who is video conferencing via a mobile phone (that supports multiple phone number profiles) has contacts who have all of their mobile phone numbers. If, for example, said person is on a videoconference call using Profile 1 and wishes to include an incoming call to Profile 2 in the conversation, then the person should be able to include the caller of Profile 2 in the videoconference call.

### SUMMARY OF THE INVENTION

The main purpose of this enhancement is ease of use for the mobile phone user. The user engaged in the videoconference call will have the option to accept incoming calls made to a mobile phone profile that is not hosting the mobile videoconference call.

### BRIEF DESCRIPTION OF THE DRAWINGS

FIG. 1 in the drawing represents a mobile phone call in progress with Mobile Phone Number #1. Data 1 and Data 2 comprise the communication interface between the Mobile Phone and a person who called Mobile Number #2. Data 1 could represent incoming messages to the Mobile Phone from the person who originated the call to Mobile Number #2. Data 2 could represent outgoing messages from the Mobile Phone to the person originating the call to Mobile Number #2. Data 3 and Data 4 comprise the communication interface between the Mobile Phone and a person who called Mobile Number #3. Data 3 could represent incoming messages to the Mobile Phone from the person who originated the call to Mobile Number #3. Data 4 could represent outgoing messages from the Mobile Phone to the person originating the call to Mobile Number #3. Data 5 and Data 6 comprise the communication interface between the Mobile Phone and a person who called Mobile Number #4. Data 5 could represent incoming messages to the Mobile Phone from the person who originated the call to Mobile Number #4. Data 6 could represent outgoing messages from the Mobile Phone to the person originating the call to Mobile Number #4. Data 7 and Data 8 comprise the communication interface between the Mobile Phone and a person who called Mobile Number #5. Data 7 could represent incoming messages to the Mobile Phone from the person who originated the call to Mobile Number #5. Data 8 could represent outgoing messages from the Mobile Phone to the person originating the call to Mobile Number #5.

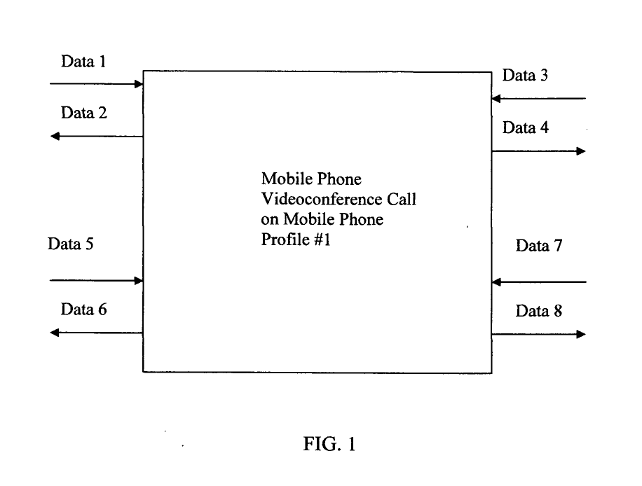

### DETAILED DESCRIPTION OF THE PREFERRED EMBODIMENTS

The software required to support this enhancement will be available on a password protected internet site. The software could also be made available through the wireless phone company that supports this software invention. If any of the calls being merged gets dropped during the conversation, then the caller will be able to return to the videoconference call directly as long as the videoconference call is still in progress. The caller will be able to dial the same initial number as before (even if the initial number was not the profile hosting the videoconference call).

1. A logical software device on the mobile phone that supports all claims listed in patent application titled The Mobile Phone with Multiple Mobile Phone Number Profiles (U.S. patent application Ser. No. 13/317,688, Patent Filing Date Oct. 26, 2011).

2. The software described in claim 1 will allow a user involved in a video conference call on a mobile phone profile to add incoming calls that are made to different mobile phone number profiles (not hosting the videoconference call).
